(19) United States
(12) Patent Application Publication
(10) Pub. No.: US 2008/0066656 A1
(43) Pub. Date: Mar. 20, 2008

(54) Integral Sealer Admixture Composition For Improving The Performance Of Concrete And Other Cementitious Systems, Mixtures, And Products

(75) Inventor: William W. Supplee, Hampton, NJ (US)

Correspondence Address: DUANE MORRIS LLP, PO BOX 5203, PRINCETON, NJ, 08543-5203, US

(73) Assignee: General Redi-Chem, Inc., Oxford, NJ (US)

(21) Appl. No.: 11/857,360

(22) Filed: Sep. 18, 2007

Related U.S. Application Data
(60) Provisional application No. 60/845,408, filed on Sep. 18, 2006.

(51) Int. Cl. C04B 7/345; C04B 28/02

(52) U.S. Cl. 106/809; 106/638; 524/650

(57) ABSTRACT

An admixture composition for inclusion into concrete or other cementitious systems and mixtures includes at least one sealing agent, at least one dispersant agent, and optionally, at least one accelerator agent. The admixture composition allows for the production of concrete and other cementitious products with integral sealing agents.

### RELATED APPLICATIONS

This application claims the benefit of U.S. Provisional Application Ser. No. 60/845,408, filed on Sep. 18, 2006, the entire disclosure of which is incorporated herein by reference.

### FIELD OF THE INVENTION

The invention relates to concrete and other cementitious systems, mixtures, and products. More particularly, the invention relates to an integral sealer admixture composition for concrete and other cementitious systems, mixtures and products that prevents water penetration, retains maximum water for cement hydration, reduces permeability, and provides improved primary and secondary efflorescence control.

### BACKGROUND OF THE INVENTION

Concrete is a hardened material may be formed by an aggregate material bounded in a cured or hardened cement matrix. The aggregate material may include, without limitation sand, gravel, and/or stone. Building blocks, paving stones, and roof-tiles are often made from concrete, as are certain fiber-board products. The concrete or concrete products may be formed by adding water to a mixture of the aggregate material and uncured cement. The aggregate material and uncured cement made be provided in a ready to mix package Concrete products may be form by and ready mix concrete, are made from concrete systems. There are a variety of known compositions that may be applied to the surface of concrete to protect it from chemical and environmental exposure. Such compositions are commonly referred to as sealers or sealants. Most of these sealants form a protective film over the exposed surface of the concrete. A few of these sealants have chemistries, which enable them to actually penetrate into the exposed surface of the concrete. The penetration of these sealants, however, is generally limited to no more than a few millimeters into the exposed surfaces they are applied to.

Mechanical wear, chemical and/or environmental exposure, biological degradation, and ultraviolet deterioration, generally cause these sealants to fail within a relatively short time frame of several months to a few years. In addition, sealants have no real impact on the performance characteristics of the concrete i.e., compressive strength, flexural strength, durability, resistance to long term chemical exposure, freeze thaw degradation, primary efflorescence salt formation, and long term secondary salt migration.

In addition, most commonly known water resistant admixtures, hydrophobic admixtures and efflorescence control agents contain large quantities of calcium stearate. Calcium stearate has been shown to significantly accelerate the rate of deterioration of any concrete system that is exposed to a freeze thaw environment. This can result in total failure of the concrete system that calcium stearate is applied to in less than 100 cycles of freezing and thawing.

A large fraction of the cement used in concrete never hydrates. This has been confirmed by petrographic analysis, which is a technique that measures the actual quantity of Unhydrated Portland Clinker or UPC content. Petrographic analysis results show that the quantity of UPC in concrete can vary from as low as 10% to as high as 40%. The ability to recapture the UPC content is very important in today's market because of the ever increasing cost and limited availability of cement.

Chemical admixtures for cement include any substance that is added to a concrete system or other cementitious system that is not cement or a mineral aggregate. Chemical admixtures are added to a concrete system or other cementitious system to enhance the performance of the system. Examples of common concrete chemical admixtures are those specified in ASTM C494 Standard Specifications for chemical admixtures in concrete. The ASTM standards cover the basic requirements for chemicals to be used as admixtures in concrete to produce specific modifications to the initial set character, final set character and finished cementitious product performance specifications of the concrete system they are being applied to. The admixtures listed in the ASTM specification generally include organic, inorganic, and mineral chemicals that produce various physical and chemical effects in the concrete and cementitious system they are added to. These physical and chemical effects include without limitation set acceleration, set retardation, viscosity modification, compressive strength enhancement, flexural strength enhancement, water and chemical resistance, permeability reduction, air entrainment and efflorescence control.

In view of the foregoing, an admixture composition for inclusion into concrete and other cementitious systems is needed that provides, chemical and environmental protection throughout the entire concrete system, improved cement hydration, improved durability, and reduction of efflorescence salts.

### SUMMARY

Disclosed herein is an admixture composition for inclusion into concrete or other cementitious systems and mixtures. The admixture composition comprises at least one sealing agent and at least one dispersant agent, wherein the at least one sealing agent comprises between about 0.1 and about 90 percent by weight of the admixture composition and the at least one dispersant agent comprises between about 0.1 and about 50 percent by weight of the admixture composition.

Also disclosed herein is a concrete or cementitious product comprising at least one sealing agent distributed throughout the external and internal structure of the concrete or cementitious product.

Also disclosed herein is a concrete or cementitious product comprising at least one dispersant agent distributed throughout the external and internal structure of the concrete or cementitious product.

Further disclosed herein is a method of making a concrete or cementitious product. The method comprises providing an admixture composition comprising at least one sealing agent and at least one dispersant agent, adding the admixture composition to a concrete or cementitious slurry and forming the concrete or cementitious slurry containing the admixture composition into the concrete or cementitious product.

### BRIEF DESCRIPTION OF THE DRAWINGS

FIG. 1 is a schematic partial sectional view of a concrete or cementitious product containing an integral sealing agent.

FIG. 2 is a flowchart of an embodiment of a method for making a concrete or cementitious products with an integral sealing agent.

### DETAILED DESCRIPTION OF THE INVENTION

The term “sealing agent” as used herein refers to a chemical or plurality of chemicals that are known to provide water, chemical and environmental exposure resistance to concrete and cementitious systems. Examples of known sealing agents include, but are not limited to, acrylic polymers, styrene polymers, urethane polymers, neoprene polymers, polyesters, polyepoxy, silicones, silanes, and siloxanes.

The term “accelerator agent” as used herein refers to a chemical or plurality of chemicals that are known to reduce the time required for the initial set of the uncured concrete or other cementitious system. Examples of known accelerator agents include, but are not limited to, calcium chloride, calcium nitrate, calcium nitrite, and formic acid.

The term “dispersant agent” as used herein refers to a chemical or plurality of chemicals that are known to provide more complete hydration and improved performance efficiency of cement. As used herein, dispersant agent refers to plasticizer chemicals or super-plasticizer chemicals when used as low range and high range water reducers. Examples of known dispersant agents, include but are not limited to, lignin salts, naphthalene sulfonate, polycarboxylated acrylics, salts of carboxylic acids, cocomide derivatives, and detergents.

The term a “concrete” or “cementitious” as used herein refers to a system or mixture (prior to mixing with water or any other suitable solvent) containing at least one or more aggregate materials (sand, stones, gravel and the like), one or more cements (e.g. types I-V), and optionally, one or more suitable concrete additives.

In accordance with a first embodiment, an integral sealer admixture composition comprising one or more sealing agents, one or more accelerator agents, one or more cement specific dispersant agents, and a solvent. The amount of the one or more sealers in the admixture composition ranges between about 0.1 percent and about 90.0 percent by weight of the total admixture composition, and preferably between about 0.5 percent and about 30.0 percent by weight of the total admixture composition and most preferably between about 1.0 percent and about 10.0 percent by weight of the total admixture composition. The amount of the one or more accelerators in the admixture composition ranges between about 0.1 percent and about 95.0 percent by weight of the total admixture composition, and preferably between about 50.0 percent to about 90.0 percent by weight of the total admixture composition, and most preferably between about 70.0 percent and about 88.0 percent by weight of the total admixture composition. The amount of the one or more dispersants in the admixture composition ranges between about 0.1 percent and about 50.0 percent by weight of the total admixture composition, and preferably between 3.0 percent and 25.0 percent by weight of the total admixture composition, and most preferably between about 5.0 percent and about 15.0 percent by weight of the total admixture composition. The solvent, which preferably comprises water, is added to the admixture composition in a weight percent amount that makes up the balance of the total admixture composition.

In some embodiments, the integral sealer admixture composition may further comprise one or more property enhancing additives including, but are not limited to surfactants, rheological control agents, biological control agents and mixtures thereof In other embodiments, the one or more accelerator agents may be omitted from the integral sealer admixture composition.

In a preferred embodiment of the integral sealer composition, the amount of the one or more sealing agents comprises about 4.0 percent by weight of the total admixture composition, the amount of the one or more accelerator agents comprises about 10.0 percent by weight of the total admixture composition, the amount of the one or more dispersant agents comprises about 10.0 by weight of the total admixture composition and the amount of the solvent comprises about 76.0 percent weight of the total admixture composition.

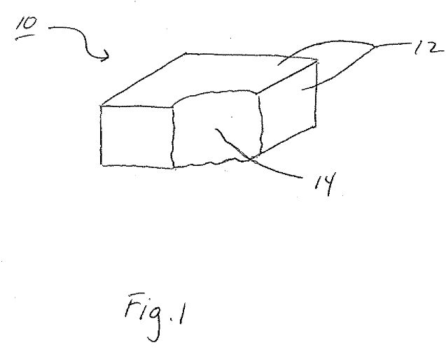

As illustrated in FIG. 1, the integral sealer admixture composition allows for the production of concrete and other cementitious (concrete/cementitious) products, e.g., concrete block 10 in FIG. 1, with integral sealing agents, i.e., where the sealing agent or agents is/are dispersed or distributed throughout the entire body of the uncured and cured concrete/cementitious product including the outer surface(s) 12 and micro-pore inner structure 14 thereof, thereby protecting the entire product 10 from water, chemical and environmental exposure. Such concrete/cementitious products may be formed, in one embodiment, by adding the integral sealer admixture composition to a concrete/cementitious system or mixture at the time or point of use of the system or mixture (i.e., when the concrete/cementitious system or mixture is being mixed with water to form a slurry). The amount of the integral sealer admixture composition that may be added to the concrete/cementitious system or mixture slurry typically ranges between about 0.1 percent and about 50.0 percent by weight of the cement in the concrete/cementitious system or mixture slurry. The amount of the integral sealer admixture composition added to the concrete/cementitious system or mixture slurry depends upon the concrete/cementitious product being specified, i.e., the desired performance requirements of the concrete/cementitious product.

The one or more sealing agents of the integral sealer admixture composition reduce water loss during the concrete/cementitious curing process, improve cement dispersion and hydration, provide protection during the curing of and in the finished concrete/cementitious product to prevent water penetration, reduce permeability, and provide improved primary and secondary efflorescence control. The one or more sealing agents in the integral sealer admixture composition comprise, but are not limited to, acrylic polymers, styrene polymers, urethane polymers, neoprene polymers, polyesters, polyepoxy, silicones, silanes, siloxanes and combinations thereof.

The one or more accelerator agents of the integral sealer admixture composition raise the heat of hydration, aiding the initial set and formation of the micro-pore structure of the final concrete/cementitious product. More specifically, the one or more accelerator agents shorten the time to initial set and generate heat from the hydration process which in turn, accelerates the set of the one or more sealers of the composition providing nearly instant water resistance and resistance to water migration in the uncured and cured concrete/cementitious product and reduces the formation of primary and secondary salts. The one or more accelerator agents in the integral sealer admixture composition comprise, but are not limited to, calcium chloride, calcium nitrate, calcium nitrite, formic acid and combinations thereof.

The one or more dispersants of the integral sealer admixture composition allow for more complete hydration and improved performance efficiency of the cement in the concrete/cementitious product. The one or more dispersants in the integral sealer admixture composition comprise plasticizers and/or super-plasticizers. Such plasticizers and super-plasticizers comprise, but are not limited to, lignin salts, naphthalene sulfonate, polycarboxylated acrylics, salts of carboxylic acids, cocomide derivatives, detergents and combinations thereof.

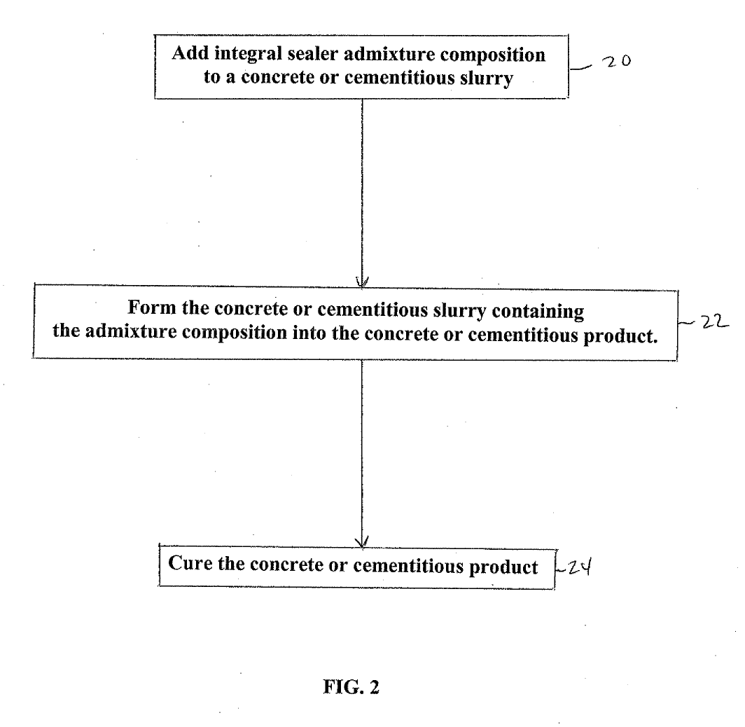

FIG. 2 illustrates an embodiment of a method for making a concrete or cementitious products with an integral sealing agent. Such concrete or cementitious products may comprise, but are not limited to, roof tiles, paving stones, blocks, and retaining walls. In step 20 of the method, the admixture composition comprising the one or more sealing agents, the one or more accelerator agents, the one or more dispersant agents, the solvent, and optionally, the one or more property enhancing additives, is added to a concrete or cementitious slurry. In step 22 of the method, the concrete or cementitious slurry containing the admixture composition is dispensed into a form or mold, or sprayed, etc., to create the concrete or cementitious product. In step 24, the concrete or cementitious product is cured.

When added to cement, the admixture composition's chemical blend and modification of the one or more accelerator agents with the one or more dispersant agents (plasticizer or super-plasticizer) combined with the one or more sealing agents, yields improved hydration of the cement particles of the concrete/cementitious system or mixture, improved resistance to water permeability throughout the body of the concrete/cementitious product, significant reduction in primary and secondary salts migration in the concrete/cementitious product, and improved curing of the concrete/cementitious product through the retention of the water of phase I hydration, thereby improving overall cement hydration quantities. The performance enhancements to concrete and cementitious systems, mixtures, and products is shown in the following examples.

### EXAMPLE 1

The integral sealer admixture composition is illustrated in Example 1 and was prepared using silane (HE 328 from Degussa Corporation) as a sealing agent, calcium chloride (Chem-Accel from Dow Chemical Company) as an accelerator agent, and lignosulphonate (Ligno S007 from KemTek Industries Inc.) as a dispersant agent. More specifically, 5 gallons of a 32% solution of the calcium chloride accelerator agent was dispensed into a high-speed cowls-type mixer. To this 0.6 gallons of a 10% solution of Ligno S007 was blended in the mixer. After 5 minutes, 0.13 gallons of HE328 silane sealing agent was added to the accelerator and dispersant agent mixture. The materials were blended for approximately 15 minutes. The final admixture had a solids content of approximately 30% and a viscosity of approximately 1100 cps on a Brookfield viscometer using a spindle #6.

### EXAMPLE 2

Repeat of Example 1 except with a naphthalene sulfate dispersant agent.

### EXAMPLE 3

Repeat of Example 1 except with a polycarboxylated acrylic dispersant agent.

### EXAMPLE 4

Repeat of Example 1 except with a calcium nitrate accelerator agent.

### EXAMPLE 5

Three types of concrete systems were compared to a control system to determine the effects of the admixture of Example 1 on ageing under natural environment conditions. Each concrete system used a base material of 100 g of type one Portland cement and 300 grams of typical concrete grade sand blended with a Hobart laboratory mixer under typical laboratory conditions, An appropriate amount of water was added to produce a water to cement ratio of 0.3 to 0.4. Color was adding to each concrete composition using black iron oxide colorant at 5% by weight of the total concrete composition. For one testing group, an amount of the admixture composition of Example 1 equal to 3% by weight of the cement in the concrete composition was added. For another testing group, an amount of the admixture composition of Example 1 equal to 1.5% by weight of the cement in the concrete composition was added. For yet another testing group, CaCl equal to 3% by weight of the cement in the concrete composition was added. In the control group, no additional additive was used. Each concrete system was mixed until ingredients were uniformly distributed.

After mixing, concrete slabs were prepared. For each slab approximately 75 g of a concrete system was transferred to a laboratory 3″×5″ steel mold. Afterwards, a 10,000 lbs per square inch force was applied for 30 seconds using a laboratory press. For compressive strength testing, a an appropriate amount of the concrete system was inserted into a cylinder mold 1.5″ in diameter and 3″ in length. Similar molds were prepared in parallel using the control concrete without admixture. The completed units were then transferred to a 95% relative humidity oven at 130 degrees Fahrenheit for 24 hours.

For each sample slab initial color measurements were taken on an ACS spectrophotometer for later comparison with the same sample after ageing. To control for the effect of age on color, two samples from both each group were then placed in a dark humidity controlled environment for later comparison to environmentally aged samples. Natural ageing was used in the Example instead of accelerated ageing tests such as Weather meter and Carbon Arc tests, The test samples were placed on an outdoor table or rack at a 30-degree angle facing South in Oxford, N.J. The climate of the this site typically includes intense sun exposure in the summer months, freeze-thaw conditions in the winter months and significant rainfall in the spring months. At one months, intervals slabs of each type were sampled. Upon sampling, the slabs were rinsed with distilled water to remove deposited dirt and migrated salts that can interfere with accurate color measurements. The slab samples were measured with the colorimeter and the aged data was then compared with the initial color measurements for that particular slab. In addition, the monthly samples were tested for comparative compressive strength, absorption, permeability testing and freeze-thaw durability. Permeability was determined with the Rylem tube method using ASTM test procedures. Samples were tested for freeze thaw durability testing of 100 cycles per ASTM testing procedures (ASTM D65).

Table I shows the result of 1 year of natural environmental ageing. The data clearly shows the effect of the applied composition. When compared to the control, the concrete prepared with the admixture of Example 1 clearly demonstrates reduced water permeability resulting in reduced secondary salt migration. The improvement can also be demonstrated through superior retention of the initial color value in the slab that were prepared with the admixture of Example 1. Table I also shows the effects of the composition on compressive strength, flexural strength, absorption and freeze thaw when compared to the control units.

TABLE I

| | Control No | | Admixture of |
|---|---|---|---|
| Sample I.D. | Admixture | Control CaCl | Example 1 at 3.0% |
| Sample Age | | | |
| 1 Week | 1.4 | 1.6 | 0.2 |
| 4 Week | 5.4 | 1.8 | 0.3 |
| 2 Month | 4.8 | 4.6 | 0.6 |
| 3 Month | 5.4 | 6.6 | 0.4 |
| 4 Month | 8.2 | 9.3 | 0.6 |
| 5 Month | 11.6 | 10.4 | 0.6 |
| 6 Month | Failed | Failed | 0.8 |
| 7 Month | Failed | Failed | 1.1 |
| 8 Month | Failed | Failed | 1.4 |
| 9 Month | Failed | Failed | 1.2 |
| 10 Month | Failed | Failed | 1.4 |
| 11 Month | Failed | Failed | 1.4 |
| 12 Month | Failed | Failed | 1.5 |

Color Measurement CIE Lab Delta E
Compressive strength psi 3 sample average

| Control No admix | Control CaCl | 1.5% Admixture | 3% Admixture |
|---|---|---|---|
| 5350 psi | 6625 psi | 6975 psi | 7800 psi |

Absorption 2 unit average in percent by weight of the dry unit

| | | | |
|---|---|---|---|
| 4.60% | 4.80% | 4.90% | 4.60% |

Freeze thaw 100 cycles(−15) degrees to room temperature
one cycle per day fresh water
Specification allows for 1% maximum loss by weight

| | Control | | 1.5% | 3% |
|---|---|---|---|---|
| | No admix | Control CaCl | Admixture | Admixture |
| Initial unit weight gms | 406.3 | 403.8 | 410.6 | 405.5 |
| Final weight gms | 378.3 | 383.4 | 408.2 | 405 |
| Weight Loss gms | 28 | 20.4 | 2.4 | 0.5 |
| Weight Loss % | 6.9 | 5.1 | 0.6 | 0.1 |
| Pass/Fail | Fail | Fail | Pass | Pass |

### EXAMPLE 6

In this Example the conditions of preparation and testing as described in Example 5 were repeated using the admixture composition produced in Example 2. The testing data generated for the compositions created with the admixture composition of Example 2 and the control groups are presented in Table II.

TABLE II

| | Control No | | Admixture of |
|---|---|---|---|
| Sample I.D. | Admixture | Control CaCl | Example 2 at 3.0% |
| Sample Age | | | |
| 1 Week | 0.6 | 1.1 | 0 |
| 4 Week | 2.2 | 1.8 | 0.1 |
| 2 Month | 2.8 | 3.3 | 0 |
| 3 Month | 3.6 | 7.4 | 0.3 |
| 4 Month | 4.4 | 10.8 | 0.6 |
| 5 Month | 8.1 | Failed | 0.9 |
| 6 Month | Failed | Failed | 0.8 |

Color Measurement CIE Lab Delta E
Compressive strength psi 3 sample average

| Control No admix | Control CaCl | 1.5% Invention | 3% invention |
|---|---|---|---|
| 5350 psi | 6625 psi | 6975 psi | 7800 psi |

Absorption 2 unit average in percent by weight of the dry unit

| | | | |
|---|---|---|---|
| 5.40% | 5.20% | 4.60% | 4.10% |

Freeze thaw 100 cycles(−15) degrees to room temperature one
cycle per day fresh water
Specification allows for 1% maximum loss by weight

| | Control | | 1.5% | 3% |
|---|---|---|---|---|
| | No admix | Control CaCl | Admixture | Admixture |
| Initial unit weight gms | 401.8 | 404.3 | 403.8 | 402.2 |
| Final weight gms | 366.4 | 379.3 | 397.8 | 401.8 |
| Weight Loss gms | 35.4 | 25 | 6.2 | 0.4 |
| Weight Loss % | 8.8 | 6.2 | 1.5 | 0.1 |
| Pass/Fail | Fail | Fail | Fail | Pass |

### EXAMPLE 7

In this example the conditions of preparation and testing as described in Example 5 were repeated using the admixture composition produced in Example 3. The testing data generated for the compositions created with the admixture composition of Example 3 and the control groups are presented in Table III.

TABLE III

| Sample I.D. | | | Admixture |
|---|---|---|---|
| Sample Age | Control No Admixture | Control Admix | Example 3 |
| 1 Week | 0.3 | 0.3 | 0.1 |
| 4 Week | 1.8 | 0.5 | 0.3 |
| 2 Month | 2.7 | 0.3 | 0.3. |
| 3 Month | 4.9 | 1.2 | 0.7 |
| 4 Month | 4.7 | 4.1 | 0.4 |
| 5 Month | 6.8 | 3.8 | 0.3 |
| 6 Month | 7.2 | 4.9 | 0.3 |

Color Measurement CIE Lab Delta E

| | | | |
|---|---|---|---|
| Control No admix | Control Admix | 1.5% Admixture | 3% Admixture |

Compressive strength psi 3 sample average

| | | | |
|---|---|---|---|
| 5350 psi | 6625 psi | 6975 psi | 7800 psi |

Absorption 2 unit average in percent by weight of the dry unit

| | | | |
|---|---|---|---|
| 5.10% | 5.00% | 4.80% | 4.60% |

| Sample I.D. | | | Admixture |
|---|---|---|---|
| Sample Age | Control No Admixture | Control Admix | Example 3 |
| 7 Week | 8.728571429 | 5.614285714 | 0.5 |
| 10 Week | 9.896428571 | 6.478571429 | 0.7 |

### EXAMPLE 8

This Example is a field test of the concrete systems prepared using the admixture composition produced according to the procedure described in Example 1. The field tests were preformed at a roof tile facility. Samples of the admixture composition produced according the to the procedure described in Example 1 were delivered to roof tile manufacturing company prior to roof tile production. The admixture composition was added to typical concrete system for use in roof tiling at a amount equal either 1.5% or 3% by weight of the cement in the concrete composition. Control tiles were produced in parallel under typical conditions with either CaCl added as 3% of the cement in the concrete composition or without any additional admixture. Sampling and testing was preformed as detailed in example 5. The results of these tests are presented in Table IV.

TABLE IV

| | | | Admixture |
|---|---|---|---|
| Sample I.D. | Control No Admixture | Control CaCl | of Example 1 |
| Sample Age | | | |
| 1 Week | 0.3 | 0.8 | 0.1 |
| 4 Week | 1.8 | 1.3 | 0.3 |
| 2 Month | 2.7 | 4.1 | 0.3. |
| 3 Month | 4.9 | 5.8 | 0.7 |
| 4 Month | 4.7 | Failed | 0.4 |
| 5 Month | 6.8 | Failed | 0.3 |
| 6 Month | 7.2 | Failed | 0.3 |

Color Measurement CIE Lab Delta E
Compressive strength psi 3 sample average

| Control No admix | Control CaCl | 1.5% Admixture | 3% Admixture |
|---|---|---|---|
| 5350 psi | 6625 psi | 6975 psi | 7800 psi |

Absorption 2 unit average in percent by weight of the dry unit

| | | | |
|---|---|---|---|
| 5.50% | 5.20% | 5.0% | 5.00% |

Freeze thaw 100 cycles(−15) degrees to room temperature
one cycle per day fresh water

| | Control | | 1.5% | 3% |
|---|---|---|---|---|
| | No admix | Control CaCl | Admixture | Admixture |
| Initial unit weight gms | 406.7 | 402.6 | 401.3 | 404.8 |
| Final weight gms | 382.4 | 387.4 | 399.6 | 402.1 |
| Weight Loss gms | 24.3 | 15.2 | 1.7 | 2.7 |
| Weight Loss % | 6 | 3.8 | 0.4 | 0.7 |
| Pass/Fail | Fail | Fail | Pass | Pass |

### EXAMPLE 9

This Example is a field test of the concrete systems prepared using the admixture composition produced according to the procedure described in Example 2. The field tests were preformed at a paver manufacturing facility. Samples of the admixture composition produced according the to the procedure described in Example 2 were delivered to the paver manufacturing facility prior to paver production. The admixture composition was added to typical concrete system for use in paver production at an amount equal to either 1.5% or 3% by weight of the cement in the concrete composition. Control pavers were produced in parallel under typical conditions with either CaCl added as 3% of the cement in the concrete composition or without any additional admixture. Before beginning the testing all pavers were aged 28 days. Sampling and testing was preformed as detailed in example 5. The results of these tests are presented in Table V.

TABLE V

| | | | Admixture of |
|---|---|---|---|
| Sample I.D. | Control No Admixture | Control CaCl | Example 2 at 3.0% |
| Sample Age | | | |
| 1 Week | 0.3 | 0.8 | 0.3 |
| 4 Week | 1.8 | 1.6 | 0.3 |
| 2 Month | 3.3 | 4.8 | 0.6 |
| 3 Month | 4.8 | 6.6 | 0.7 |
| 4 Month | 4.7 | Failed | 0.8 |
| 5 Month | 6.8 | Failed | 0.8 |
| 6 Month | 9.4 | Failed | 1.8 |

Color Measurement CIE Lab Delta E
Compressive strength psi 3 sample average

| Control No admix | Control CaCl | 1.5% Admixture | 3% Admixture |
|---|---|---|---|
| 5060 psi | 5865 psi | 6493 psi | 7450 psi |

Absorption 2 unit average in percent by weight of the dry unit

| | | | |
|---|---|---|---|
| 7.20% | 6.80% | 4.2 | 3.50% |

Freeze thaw 100 cycles(−15) degrees to room temperature
one cycle per day fresh water
Specification allows for 1% maximum loss by weight

| | Control | | 1.5% | 3% |
|---|---|---|---|---|
| | No admix | Control CaCl | Admixture | Admixture |
| Initial unit weight gms | 394.6 | 398.5 | 403.5 | 406.8 |
| Final weight gms | 377.8 | 365.6 | 400 | 405.2 |
| Weight Loss gms | 16.9 | 32.9 | 3.5 | 1.6 |
| Weight Loss % | 4.25 | 8.25 | 0.87 | 0.4 |
| Pass/Fail | Fail | Fail | Pass | Pass |

### EXAMPLE 10

In this Example the conditions of preparation and testing as described in Example 5 were repeated using the admixture composition produced in Example 4. The testing data generated for the compositions created with the admixture composition of Example 4 and the control groups are presented in Table VI.

TABLE VI

| | | | Admixture |
|---|---|---|---|
| Sample I.D. | Control No Admixture | Control CaCl | of Ex. 4 at 3.0% |
| Sample Age | | | |
| 1 Week | 0.8 | 0.8 | 0.2 |
| 4 Week | 1.4 | 1.4 | 0.5 |
| 2 Month | 0.9 | 5.6 | 0.4 |
| 3 Month | 3.8 | Failed | 1.1 |
| 4 Month | 5.1 | Failed | 1.3 |
| 5 Month | 7.7 | Failed | 1.6 |
| 6 Month | 8.6 | Failed | 2.1 |

Color Measurement CIE Lab Delta E
Compressive strength psi 3 sample average

| Control No admix | Control CaCl | 1.5% Admixture | 3% Admixture |
|---|---|---|---|
| 48760 psi | 5460 psi | 6220 psi | 6860 psi |

Absorption 2 unit average in percent by weight of the dry unit

| | | | |
|---|---|---|---|
| 6.70% | 6.90% | 5.40% | 4.30% |

Freeze thaw 100 cycles(−15) degrees to room temperature
one cycle per day fresh water
Specification allows for 1% maximum loss by weight

| | Control | | 1.5% | 3% |
|---|---|---|---|---|
| | No admix | Control CaCl | Admixture | Admixture |
| Initial unit weight gms | 404.3 | 402.5 | 406.5 | 403.2 |
| Final weight gms | 381.6 | 392.8 | 399.6 | 399.8 |
| Weight Loss gms | 22.7 | 9.7 | 6.9 | 3.4 |
| Weight Loss % | 5.6 | 2.4 | 1.7 | 0.85 |
| Pass/Fail | Fail | Fail | Fail | Pass |

### EXAMPLE 11

This Example is a field test of the concrete systems prepared using the admixture composition produced according to the procedure described in Example 1. The field tests were preformed at a concrete block manufacturing facility in Arizona. Samples of the admixture composition produced according the to the procedure described in Example 1 were delivered to the block manufacturing facility prior to block production. The admixture composition was added to typical concrete system for use in block production at an amount equal either 0.5%, 1.0%, 1.5% or 3% by weight of the cement in the concrete composition. Control blocks were produced in parallel under typical conditions without any additional admixture. Before beginning the testing all blocks were aged 28 days. Tests were conducted on site at the Arizona facility. Sampling and testing was preformed as detailed in example 5. The results of these tests are presented in Table VII below.

TABLE VII

| Sample I.D. | Strength | DeltaE | Weeks | |
|---|---|---|---|---|
| Tile Control | | | | |
| Samples | | | | |
| Black | 69% | 5.29 | 52 | Fail |
| Blue | 64% | 6.47 | 52 | Fail |
| Green | 83% | 3.55 | 52 | Fail |
| Tile Invention | | | | |
| Samples | | | | |
| Black | 84% | 2.6 | 52 | Pass |
| Blue | 93% | 1.8 | 52 | Pass |
| Green | 102% | 0.3 | 52 | Pass |

Table VIII, below, shows data obtained from a field trial of pavers made using the admixture composition of Example 2.

TABLE VIII
Field Trial of Example 2 in Pavers

| | Control No | | Example 8 at | Example 8 at |
|---|---|---|---|---|
| Sample I.D. | Admixture | Control Admix | 0.5% | 1.0% |
| Sample Age | | | | |
| 1 Week | 0.8 | 1.1 | 0.4 | 0.1 |
| 4 Week | 2.2 | 1.4 | 0.4 | 0.1 |
| 2 Month | 3.8 | 3.8 | 0.8 | 0.2 |
| 3 Month | 4 | 2.6 | 0.65 | 0.1 |
| 4 Month | 9 | 3.3 | 0.8 | 0.3 |
| 5 Month | 7.6 | 4.1 | 0.9 | 0.2 |
| 6 Month | Failed | 4.8 | 1.2 | 0.1 |

Color Measurement CIE Lab Delta E
Compressive strength psi 3 sample
average

| Control No admix | Control Admix | 1.5% Invention | 3% invention |
|---|---|---|---|
| 6650 psi | 7190 psi | 8640 psi | 9300 psi |

Absorption 2 unit average in percent by weight of the dry unit

| | | | |
|---|---|---|---|
| 6.60% | 4.30% | 4.60% | 3.90% |

Freeze thaw 100 cycles(−15) degrees to room temperature
one cycle per day fresh water

Table IX, below, shows loading data obtained from pavers made using the admixture composition of Example 1.

TABLE IX
The admixture of Example I In Laboratory Pavers at high loadings

| Sample I.D. | Strength | DeltaE | Weeks |
|---|---|---|---|
| Tile Control Samples | | | |
| Y1 - Control Red Sealed w/ CS33 5% load | 54% | 12.6 | 13 |
| Z1 - Control Green Sealed w/ CS33 5% load | 68% | 7.19 | 13 |
| A31- Control Blue Sealed w/ CS33 5% load | 48% | 12.8 | 13 |
| B1 - Control Black T19019F W/ CS33 | 57% | 9.4 | 13 |
| 5% load | | | |
| C1 - Control Yellow Sealed w/ CS33 | 38% | 13.3 | 13 |
| 5% load | | | |
| D1 - Control Orange Sealed w/ CS33 | 71% | 6.3 | 13 |
| 5% load | | | |
| E1 - Control Violet Sealed w/ CSA33 | 46% | 11.9 | 13 |
| 5% load | | | |
| Tile Invention Samples | | | |
| Y2 - Red FS Sealed w/ CS33 5% load | 108% | 1.48 | 13 |
| Z2 - Green FS Sealed w/ CS33 5% load | 92% | 7.19 | 13 |
| A3 - Blue FS Sealed w/ CS33 5% load | 104% | 4.48 | 13 |
| B3 - T19019F Sealed w/ CS33 5% load | 101% | 0.47 | 13 |
| C3 - Yellow FS Sealed w/ CS33 5% load | 94% | 4.24 | 13 |
| D3 - Orange FS Sealed w/ CS33 5% load | 92% | 3.48 | 13 |
| E3 - Violet FS Sealed w/ CS33 5% load | 108% | 6.49 | 13 |

Table X, below, shows data obtained from a field trial of blocks made using the admixture composition of Example 2.

TABLE X
The admixture of Example 2 at a Field Block Test

| | Control | | |
|---|---|---|---|
| Sample I.D, | No Admixture | Control Admix | Invention Example 1 |
| Sample Age | | | |
| 1 Week | 1.1 | 0.3 | 0.1 |
| 4 Week | 3.6 | 0.5 | 0.1 |
| 2 Month | 4 | 0.8 | 0.3 |
| 3 Month | 5 | 0.5 | 0.4 |
| 4 Month | 6.2 | 0.9 | 0.3 |
| 5 Month | 6.1 | 1.8 | 0.7 |
| 6 Month | 5.4 | 2.6 | 1.1 |
| 7 Month | 5.8 | 4.1 | 1.3 |
| 8 Month | 7.2 | 3.8 | 1.6 |
| 9 Month | 8.1 | 4.8 | 1.3 |
| 10 Month | Failed | 5.5 | 1.7 |
| 11 Month | Failed | Failed | 1.9 |
| 12 Month | Failed | Failed | 2.2 |

Color Measurement CIE Lab Delta E
Compressive strength psi 3 sample average

| Control No admix | Control Admix | 1.0% Invention |
|---|---|---|
| 2890 psi | 3150 psi | 4410 psi |

Absorption Measurements

| | | |
|---|---|---|
| 6.10% | 4.80% | 3.20% |

Absorption 2 unit average in percent by weight of the dry unit

Freeze thaw 100 cycles(−15) degrees to room temperature
one cycle per day fresh water
Specification allows for 1% maximum loss by weight(coupons)

| | | Control | |
|---|---|---|---|
| | Control No admix | Admix | 1.0% Invention |
| Initial unit weight gms | 402.1 | 404.8 | 405.6 |
| Final weight gms | 391.6 | 388.4 | 403.8 |
| Weight Loss gms | 10.5 | 16.4 | 1.8 |
| Weight Loss % | 2.6 | 4 | 0.45 |
| Pass/Fail | Fail | Fail | Pass |

It can be clearly seen from the examples and data that the integral sealer admixture compositions disclosed herein provide the desired result of improving the performance characteristics of a variety of concrete products in multiple concrete/cementitious systems. The data for the samples made with the integral sealer admixture compositions disclosed herein, when compared to the control test units, clearly show the dramatic improvements including better hydration of the cement particles, reduced permeability, increased compressive strength, the reduction of color loss due to migration of salts of efflorescence, and improved freeze thaw durability. All test were conducted in accordance with NCMA and ASTIM procedures. The single blended integral sealer admixture composition disclosed herein clearly demonstrates improved performance over surface applied chemical sealers with their integral hydrophobic agents, yielding more efficient use of the cement in the concrete/cementitious system, mixture and product and a reduction in cost of finished products.

The compositions, products and methods disclosed herein may be embodied in other specific forms without departing from the spirit or essential attributes of the disclosure. Accordingly, reference should be made to the appended claims, rather than the foregoing specification, as indicating the scope of the invention.

What is claimed:

1. An admixture composition for inclusion into concrete or other cementitious systems and mixtures, the admixture composition comprising at least one sealing agent and at least one dispersant agent, wherein:
the at least one sealing agent comprises between about 0.1 and about 90 percent by weight of the admixture composition; and
the at least one dispersant agent comprises between about 0.1 and about 50 percent by weight of the admixture composition.

2. The admixture composition of claim 1, wherein the at least one sealing agent comprises between about 0.5 and about 30 percent by weight of the admixture composition.

3. The admixture composition of claim 1, wherein the at least one sealing agent comprises between about 1 and about 10 percent by weight of the admixture composition.

4. The admixture composition of claim 1, further comprising at least one accelerator agent wherein the at least one accelerator agent comprises between about 0.1 and about 95 percent by weight of the admixture composition,

5. The admixture composition of claim 4, wherein the at least one accelerator agent comprises between about 50 and about 90 percent by weight of the admixture composition.

6. The admixture composition of claim 4, wherein the at least one accelerator agent comprises between about 70 and about 88 percent by weight of the admixture composition.

7. The admixture composition of claim 1, wherein the at least one dispersant agent comprises between about 3 and about 25 percent by weight of the admixture composition.

8. The admixture composition of claim 1, wherein the at least one dispersant agent comprises between about 5 and about 15 percent by weight of the admixture composition.

9. The admixture composition of claim 1, wherein the at least one sealing agent is selected from the group consisting of acrylic polymers, styrene polymers, urethane polymers, neoprene polymers, polyesters, polyepoxy, silicones, silanes, and siloxanes.

10. The admixture composition of claim 4, wherein the at least one accelerator agent is selected from the group consisting of calcium chloride, calcium nitrate, calcium nitrite, and formic acid.

11. The admixture composition of claim 1, wherein the at least one dispersant agent is selected from the group consisting of lignin salts, naphthalene sulfonate, polycarboxylated acrylics, salts of carboxylic acids, cocomide derivatives, and detergents.

12. The admixture composition of claim 1, wherein the at least one sealing agent comprises silane and the at least one dispersant agent comprises lignosulphonate.

13. The admixture composition of claim 4, wherein the at least one sealing agent comprises silane, the at least one accelerator comprises calcium chloride, and the at least one dispersant agent comprises lignosulphonate.

14. The admixture composition of claim 1, packaged as a kit comprising a set of instructions for preparing a concrete or cementitious product using the at least one sealing agent and the at least one dispersant agent so that each of the at least one sealing agent and the at least one dispersant agent is distributed throughout the external and internal structure of the concrete or other cementitious product.

15. A concrete or cementitious product comprising at least one sealing agent distributed throughout the external and internal structure of the concrete or cementitious product.

16. The concrete or cementitious product of claim 15, further comprising at least one accelerator agent distributed throughout the external and internal structure of the cured concrete or cementitious product.

17. The concrete or cementitious product of claim 15, further comprising at least one dispersant agent distributed throughout the external and internal structure of the concrete or cementitious product.

18. The concrete or cementitious product of claim 15, wherein the concrete or cementitious product comprises one of a roof tile, paving stone, block, and retaining wall.

19. A concrete or cementitious product comprising at least one dispersant agent distributed throughout the external and internal structure of the concrete or cementitious product.

20. The concrete or cementitious product of claim 19, wherein the concrete or cementitious product comprises one of a roof tile, paving stone, block, and retaining wall.

21. A method of making a concrete or cementitious product, the method comprising the steps of:
providing an admixture composition comprising at least one sealing agent and at least one dispersant agent;
adding the admixture composition to a concrete or cementitious slurry; and
forming the concrete or cementitious slurry containing the admixture composition into the concrete or cementitious product.

22. The method of claim 21, further comprising the step of curing the concrete or cementitious product.

23. The method of claim 21, wherein the admixture composition further comprises at least one accelerator agent.

24. The method of claim 21, wherein the concrete or cementitious product comprises one of a roof tile, paving stone, block, and retaining wall.
